(19) United States
(12) Patent Application Publication
(10) Pub. No.: US 2019/0360395 A1
(43) Pub. Date: Nov. 28, 2019

(54) TURBINE STATOR VANE WITH MULTIPLE OUTER DIAMETER PRESSURE FEEDS

(71) Applicant: Florida Turbine Technologies, Inc., Jupiter, FL (US)

(72) Inventors: Michelle I. CUPINI, Jupiter, FL (US); Stephen E. MURRAY, Port St. Lucie, FL (US)

(21) Appl. No.: 16/477,739

(22) PCT Filed: Jun. 1, 2017
(86) PCT No.: PCT/US2017/035359

§ 371 Date: Jul. 12, 2019

Related U.S. Application Data
(63) Continuation of application No. 15/405,467, filed on Jan. 13, 2017, now abandoned.
(60) Provisional application No. 62/295,747, filed on Feb. 16, 2016.

(51) Int. Cl. F02C 3/22; F01D 5/18; F02C 3/04; F02C 7/18; F01D 9/02; F01D 9/06

(52) U.S. Cl. CPC F02C 3/22; F01D 5/187; F02C 3/04; F02C 7/18; F01D 9/041; F01D 9/065; Y02E 20/16; F05D 2250/185; F05D 2220/72; F01D 9/02

(57) ABSTRACT

A stator vane assembly for a gas turbine engine in which both higher pressure cooling air and lower pressure cooling air are both supplied to the stator vane assembly to cool both an airfoil and inner and outer diameter endwall cavities of the stator vane assembly, in which the spent higher pressure cooling air is then discharged into a combustor of the gas turbine engine. The higher pressure cooling air flows through a closed loop cooling circuit formed within the stator vane assembly while the lower pressure cooling air is discharged through exit holes into the hot gas stream of the turbine.

### CROSS-REFERENCE TO RELATED APPLICATIONS

This application is a Submission under 35 U.S.C. § 371 for U.S. National Stage Patent Application of, and claims priority to, International Application Number PCT/US2017/035359 entitled TURBINE STATOR VANE WITH MULTIPLE OUTER DIAMETER PRESSURE FEEDS, filed Jun. 1, 2017, which is related to and claims priority to U.S. application Ser. No. 15/405,467, filed Jan. 13, 2017, the entirety of all of which are incorporated herein by reference.

### GOVERNMENT LICENSE RIGHTS

This invention was made with United States Government support under contract number DE-FE0023975 awarded by Department of Energy. The United States Government has certain rights in the invention.

### TECHNICAL FIELD

The present invention relates generally to a gas turbine engine, and more specifically to an industrial gas turbine engine with spent airfoil cooling air discharged into a combustor.

### BACKGROUND

The current state-of-the-art in gas turbine vane OD (outer diameter) multi-cooling feed is disclosed, for example, in the prior art patent U.S. Pat. No. 8,961,108 issued to Bergman et al. on Feb. 24, 2015 (see Bergman et al., FIG. 1). In this approach, the cooling system contains two cooling flow passageways, through a mounting hook, that are not in fluid communication with each other, fed by the same first high pressure plenum. A second plenum supplies the aft cavities of the stator with an intermediate pressure. High pressure and intermediate pressure flows are extracted from the flow of the compressed air from the compressor located on the same centerline. As shown, the flow is provided through plenums at the BOAS (blade outer air seal) and the vane OD endwall. The flow is then routed and split through the mounting hooks (passageways 1 & 2, fed from plenum (45)) and directed into the aft cooling air passages for cooling flow passageway 3 (F3, fed from plenum (65)).

In this current state-of-the-art multi-feed cooling technique of the Bergman et al. patent, the first plenum supplied by the compressor high pressure air feeds the first passage and second passages. The first passage supplies the compressor bleed high pressure cooling air to the adjacent BOAS. The second passage is routed through the mounting hook and supplies the same (first) plenum cooling air to the vane OD and the airfoil leading edge. The second plenum, supplied by the compressor from an earlier stage of the compressor and therefore has lower pressure then feeds the third passage from the vane OD into the trailing edge cooling channels of the airfoil. The second passage cooling air then exits the leading edge through film holes and the third passage cooling air exits the trailing edge of the airfoil to mix with the hot gas stream passing through the turbine. The mixing of spent cooling air with the hot gas stream results in performance and power losses to the machine. Higher pressure air also introduces leakages at the vane OD endwall, which in this technique were reduced with the addition of multiple seals, shown, for example, in the Bergman et al. patent. However, with high pressure or over-pressurized cooling air, these seals can contribute to large leaks of the cooling air into the gas path.

Introduction of over-pressurized cooling air recirculated through the turbine stator vane would introduce a significant amount of leakage flow at the OD and ID (inner diameter) if used for cooling the surrounding hooks, pre-swirler or U-rings, downstream ring segments, and the back side of vane endwalls. A second lower-pressure source is introduced and an updated configuration to fit multiple feed plumbing into the vane OD was developed here to address this issue.

### SUMMARY

The present invention advantageously provides a method and system for the use of multiple feed and extraction tubes for cooling of turbine stator vanes. Specifically, the present invention relates generally to cooled turbine components and specifically to turbine stator vanes fed with cooling air having multiple pressures including recirculated cooling air which has been over-pressurized relative to the compressor exit to reduce leakages while enhancing power output and thermodynamic efficiency. A higher pressure cooling air is passed through a stator vane in a closed loop cooling circuit in which the spent cooling air is then discharged into the combustor. The higher pressure cooling air is required to provide both cooling for the stator vane and have enough pressure to flow into the combustor. A lower pressure cooling air is used to provide cooling for the endwalls and hooks of the stator vane, where this spent cooling air is then discharged into the hot gas stream.

In one embodiment, a stator vane assembly for a gas turbine engine having a closed loop cooling circuit includes: a casing or vane carrier; a higher pressure cooling air supply passage in the casing or vane carrier; a higher pressure cooling air exit passage in the casing or vane carrier; a stator vane including an airfoil and being secured to the casing or vane carrier; an outer diameter endwall cavity formed between the casing or vane carrier and the stator vane; an internal airfoil cooling circuit formed within the airfoil of the stator vane; a first higher pressure cooling air feed tube extending through the outer diameter endwall cavity and connecting the higher pressure cooling air supply passage to the internal airfoil cooling circuit of the airfoil of the stator vane; and, a second higher pressure cooling air feed tube extending through the outer diameter endwall cavity and connecting the internal airfoil cooling circuit of the airfoil of the stator vane to the higher pressure cooling air exit passage.

Another aspect of the embodiment includes inner diameter endwall cavity formed on an inner diameter of the stator vane; a lower pressure cooling air supply passage in the outer diameter platform and opening into the outer diameter endwall cavity; a lower pressure cooling air bypass passage in the airfoil of the stator vane connecting the outer diameter endwall cavity to the inner diameter endwall cavity; an outer diameter lower pressure exit hole connected to the outer diameter endwall cavity; and an inner diameter lower pressure exit hole connected to the inner diameter endwall cavity.

In one aspect of the embodiment, the higher pressure cooling air supply passage, the higher pressure cooling air exit passage, and the internal airfoil cooling circuit form a closed loop cooling circuit through the stator vane assembly.

In one aspect of the embodiment, the gas turbine engine further comprises a compressor and a combustor, the higher pressure cooling air being at a higher pressure than a discharge pressure from the compressor of the gas turbine engine such that spent cooling from the higher pressure cooling air exit passage can be discharged into the combustor of the gas turbine engine.

In one embodiment, a method of cooling a stator vane assembly of a gas turbine engine includes: passing a higher pressure cooling air through an internal airfoil cooling circuit of an airfoil of the stator vane assembly to cool the airfoil; discharging the higher pressure cooling air from the internal airfoil cooling circuit from the stator vane assembly; passing a lower pressure cooling air into an outer diameter endwall cavity of the stator vane assembly to cool the outer diameter endwall of the stator vane assembly; passing some of the lower pressure cooling air from the outer diameter endwall cavity into an inner diameter endwall cavity through the airfoil to cool the inner diameter endwall cavity; and discharging spent cooling air from both of the outer diameter and inner diameter endwall cavities outside of the airfoil of the stator vane.

In one aspect of the embodiment, the method of cooling a stator vane assembly of a gas turbine engine further includes passing the higher pressure cooling air through the stator vane assembly in a closed loop such that the higher pressure cooling air is not in fluid communication with the lower pressure cooling air.

In one aspect of the embodiment, the method of cooling a stator vane assembly of a gas turbine engine further includes passing the higher pressure cooling air through the stator vane assembly with enough pressure so that the discharged higher pressure cooling air from the stator vane assembly has enough pressure to flow into a combustor of the gas turbine engine.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 shows a cross section top view of a closed loop cooling circuit for a turbine stator vane cooling circuit of the prior art;

FIG. 2 shows a cross section view of a stator vane in a turbine with the cooling circuit of the present invention;

FIG. 3 shows a top view of a vane doublet with the cooling circuit of the present invention;

FIG. 4 shows a top view of a vane singlet with the cooling circuit of the present invention;

FIG. 5 shows an embodiment of a combined cycle power plant with an industrial gas turbine engine of the present invention;

FIG. 6 shows another embodiment of a combined cycle power plant with an industrial gas turbine engine of the present invention in which the turbine stator vane is cooled; and

FIG. 7 shows another embodiment of a combined cycle power plant with an industrial gas turbine engine of the present invention in which the turbine stator vane is cooled.

### DETAILED DESCRIPTION

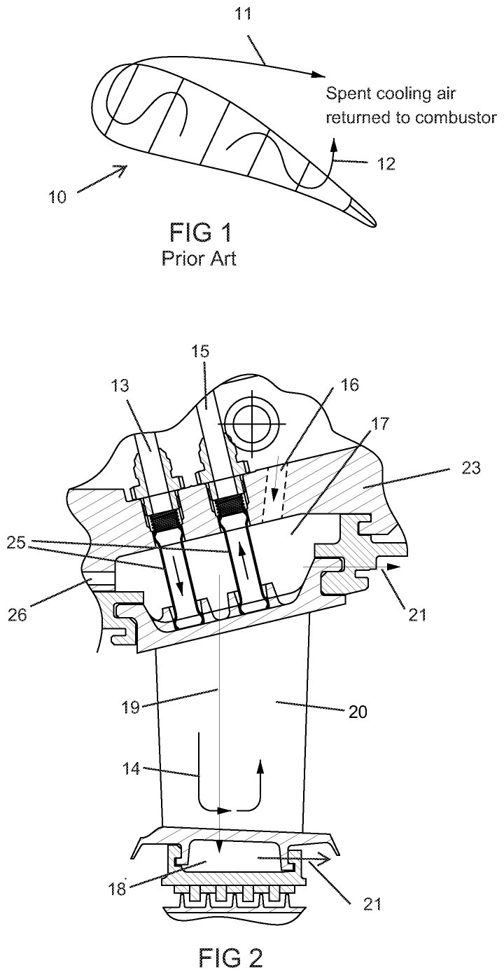

To solve problems of the current state-of-the-art and other methods utilizing pressures higher than compressor exit (over-pressurized cooling supply air) recirculated, the present invention proposes the use of multiple feed and extraction tubes consisting of supplies from over-pressurized air and compressor bleed flows, organized at the vane OD (outer diameter). The present invention is shown in conceptual form in FIGS. 1-4, but is not limited to the orientation shown in those figures.

FIG. 1 shows a stator vane 10 with a first cooling circuit 11 for a forward section of the stator vane airfoil and a second cooling circuit 12 for an aft section of the stator vane airfoil. Both cooling circuits 11 and 12 are configured to contain higher pressure cooling air that first provides cooling for the stator vane 10 and second has enough remaining pressure to be discharged into the combustor along with the compressed air discharged from the compressor. FIG. 1 shows two high pressure cooling circuits, but it will be understood that in one embodiment the stator vane 10 could have only one high pressure cooling circuit where the spent cooling air is discharged into the combustor.

FIG. 2 shows a cross section side view of a stator vane with cooling circuits according to the present invention where a higher pressure cooling air is used along with a lower pressure cooling air to provide cooling for the stator vane airfoil as well as the endwalls and the hooks of the stator vane. Thus, the cooling circuits may be referred to as a higher pressure cooling air circuit and a lower pressure cooling air circuit, respectively. The stator vane(s), endwalls, and hooks may collectively be referred to as a stator vane assembly. A higher pressure cooling air flows into the higher pressure cooling air supply passage 13, which then flows through an internal airfoil cooling circuit 14 to provide cooling for the airfoil of the stator vane 20. The higher pressure spent cooling air then flows out from the airfoil through higher pressure cooling air exit passage 15 from where the spent cooling air is discharged into the combustor. This higher pressure cooling air can be merged with compressor outlet air in a diffuser positioned between the compressor outlet and the combustor inlet. The higher pressure cooling air circuit is a closed loop cooling circuit in which none of the cooling air is discharged out film holes into the hot gas stream passing through the turbine.

The OD endwall and ID (inner diameter) endwall and hooks of the stator vane 20 are cooled using lower pressure cooling air such as that bled off from the compressor. The vane hooks are attached to a casing of the engine or in some cases to a vane carrier 23 that is secured to the casing. A lower pressure cooling air supply passage 16 delivers lower pressure cooling air to the stator vane 20 to provide cooling for the OD endwall cavity 17 and the ID endwall cavity 18 and surrounding areas through a lower pressure cooling air bypass passage 19 formed within the airfoil of the stator vane 20. The lower pressure cooling air can be discharged from the two endwall cavities 17 and 18 into the hot gas stream through exit holes 21 or other exits including trailing edge exit holes or other exit holes in the airfoil. By using lower pressure cooling air instead of the high pressure cooling air in places that discharge the spent cooling air from the stator vane 20 and into the hot gas stream, higher pressure seals are not required. The higher pressure cooling air is required so that the spent cooling air from the stator vane 20 has a high enough pressure to be discharged into the combustor. If the higher pressure cooling air was used in places where the lower pressure cooling air is used, the higher pressure cooling air would produce a large cooling air leakage through the seals and into the hot gas stream. Thus, less higher pressure cooling air would be available for discharge into the combustor after cooling of the stator vane 20 and surrounding areas.

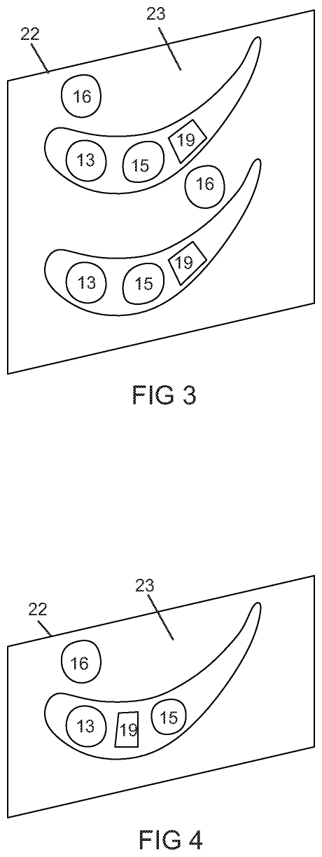

FIG. 3 shows a doublet stator vane segment in which the stator vane segment has two airfoils extending between the endwall cavities. FIG. 3 shows a turbine vane carrier 22 with a casing or vane carrier 23, a lower pressure cooling air supply passage 16 and a higher pressure cooling air supply passage 13. The higher pressure cooling air supply passage 13 and higher pressure cooling air exit passage 15 and the lower pressure cooling air bypass channel 19 formed within the airfoil are shown in FIG. 3 for the two airfoils. A second lower pressure cooling air supply passage 16 is shown in the casing or vane carrier 23 in-between the two airfoils. FIG. 4 shows a similar arrangement for a single airfoil stator vane segment.

The higher pressure cooling air circuit and the lower pressure cooling air circuit are separate cooling circuits and not in fluid communication with each other in order to reduce any leakages. Higher pressure cooling air feed tubes 25 (FIG. 2) are used to connect the higher pressure cooling air supply passage 13 and higher pressure cooling air exit passage 15 to the airfoil cooling passages 14 formed within the airfoil and to prevent the higher pressure cooling air from leaking into the lower pressure cooling air of the OD endwall cavity 17. The lower pressure cooling air supply passage 16 is formed as a hole in the casing or vane carrier 23 of the turbine to the OD endwall cavity 17. The lower pressure cooling air supply passage 16 can also be delivered to adjacent ring segments through mounting hooks on the stator vane 20.

The lower pressure cooling air source also feeds the stator vane ID endwall cavity 18 cooling through a cooling air bypass channel 19 formed within the airfoil of the stator vane 20. A first high pressure cooling air feed tube 25 (which may also be referred to as a first form fitted tube 25) extends through the OD endwall cavity 17 and connects the higher pressure cooling air supply passage 13 to the internal airfoil cooling circuit 14, and a second high pressure cooling air feed tube 25 (which may also be referred to as a second form fitted tube 25) extends through the OD endwall cavity 17 and connects internal airfoil cooling circuit 14 to the vane OD higher pressure cooling air exit passage 15, following a closed loop design for the over-pressurized air. Both feed tubes 25 have enlarged annular ends that seal the tubes 25 yet allow movement sideways or along the axis. Once a vane segment is secured in place to the casing or vane carrier 23, the feed tubes 25 are inserted through the openings in the casing or vane carrier 23, a spring is inserted above each feed tube 25, and a threaded fitting is inserted into each opening to compress the spring and secure the feed tube 25 in place. The feed tubes 25 can only be inserted when the vane segment 20 is in position on the casing or vane carrier 23. Utilizing this closed loop design in conjunction with the multi-feed multi-pressure supply allows for higher thermal efficiency, higher power output, but minimal leakage of over-pressurized cooling air into the gas-path.

FIG. 2 also shows the casing or vane carrier 23 with a cooling air hole 26. This cooling air hole 26 can be used to connect one stage or row of stator vanes with a second and adjacent row or stage of stator vanes so that the lower pressure cooling air can be supplied to one stage or row of stator vanes and then passed on to the second stage or row of stator vanes for low pressure cooling of the OD endwall cavity 17 and the ID endwall cavity 18 of the stator vanes.

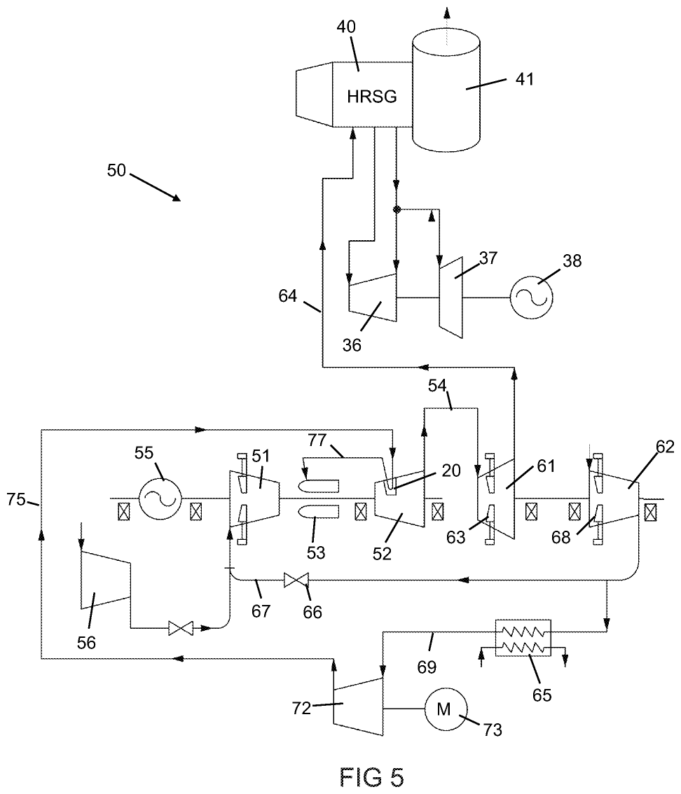

FIG. 5 shows one embodiment of a combined cycle power plant 50 of the present invention which makes use of the turbine stator vane cooling circuit shown and described in FIGS. 2-4. The combined cycle power plant 50 includes a high spool with a high pressure compressor (HPC) 51 driven by a high pressure turbine (HPT) 52 from a hot gas stream produced in a combustor 53 where the high spool drives an electric generator 55. A low spool or turbocharger includes a low pressure compressor (LPC) 62 driven by a low pressure turbine (LPT) 61 that is driven by turbine exhaust from the HPT 52. The LPT 61 includes a variable guide vane assembly 63 to regulate a speed of the LPC 62 and thus control the compressed air flow delivered to the inlet of the HPC 51. The LPC 62 includes a variable inlet guide vane assembly 68 to regulate the speed of the low spool. The LPC 62 delivers compressed air to the HPC 51. For example, compressed air may pass directly from the LPC 62 to the HPC 51 through a first compressed air line 67. Regulator valve 66 is in the compressed air line 67. Additionally or alternatively, compressed air may be diverted from the first compressed air line 67 to pass from the LPC 62 through an intercooler 65 in a second compressed air line 69 to cool the compressed air from the LPC 62. Compressed air in the second compressed air line 69 is further compressed by a boost compressor 72 driven by a motor 73 to a higher pressure than the outlet pressure of the HPC 51 so that the turbine stator vanes 20 can be cooled and the spent cooling air can be discharged into the combustor 53 through spent cooling air line 77. The higher pressure cooling air supply passage 13 and higher pressure cooling air exit passage 15 of the stator vane in FIG. 2 would be cooling air line 75 and spent cooling air line 77, respectively, in FIG. 5. The lower pressure cooling air delivered to the lower pressure cooling air supply passage 16 would be discharged from the endwall cavities 17 and 18 and into the hot gas stream passing through the HPT 52.A boost compressor 56 with valve 57 can be used to deliver low pressure air to the inlet of the HPC 51 in certain situations.

A HRSG (Heat Recovery Steam Generator) 40 with a stack 41 is used to take the exhaust gas from the LPT 61 through line 64 and to produce steam for use by a high pressure steam turbine 36 and a low pressure steam turbine 37 that are both connected to drive a second electric generator 38. The exhaust finally is discharged through the stack 41.

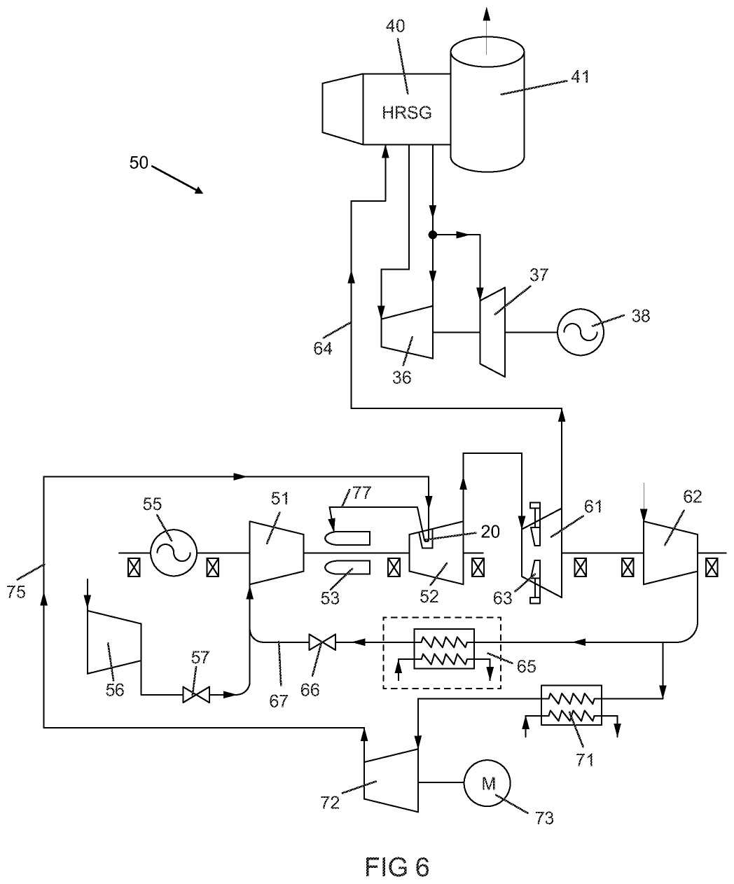

FIG. 6 shows another version of the combined cycle power plant 50 of the present invention in which the turbine stator vanes 20 are cooled using compressed air from the compressed air line 67. Some of the compressed air from the line 67 is diverted into a second intercooler 71 and then further compressed by a boost compressor 72 driven by a motor 73 to a higher pressure than the outlet pressure of the HPC 51 so that the turbine stator vanes 20 can be cooled and the spent cooling air can be discharged into the combustor 53 through spent cooling air line 77. The higher pressure cooling air supply passage 13 and higher pressure cooling air exit passage 15 of the stator vane in FIG. 2 would be cooling air line 75 and spent cooling air line 77, respectively, in FIG. 6. The lower pressure cooling air delivered to the lower pressure cooling air supply passage 16 would be discharged from the endwall cavities 17 and 18 and into the hot gas stream passing through the HPT 52.

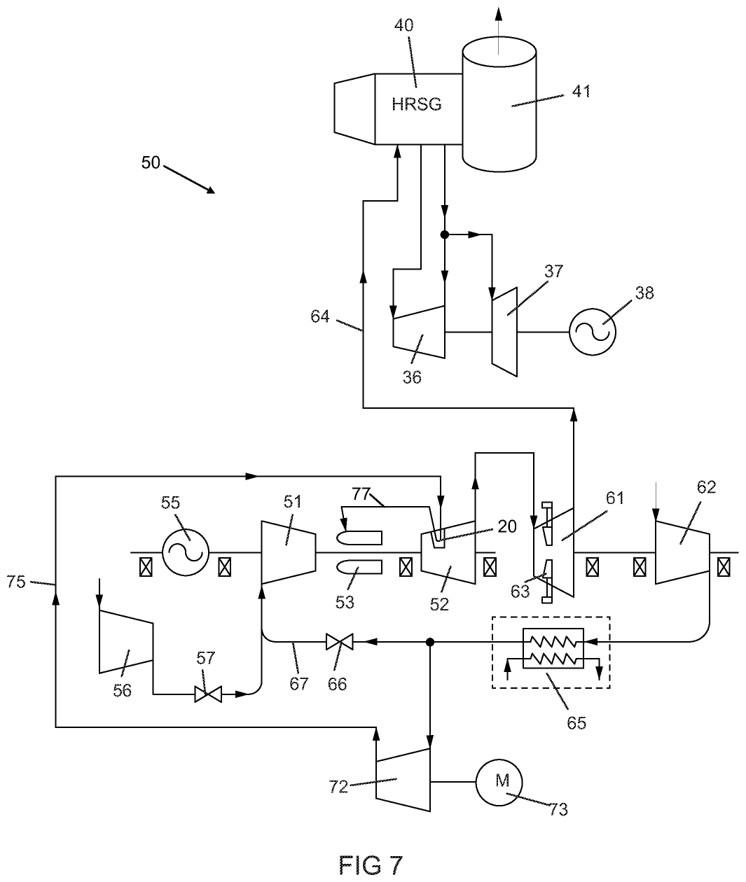

FIG. 7 shows another embodiment of the combined cycle power plant 50 similar to the FIG. 6 embodiment, in which only one intercooler 65 is used to cool the compressed air going to both the HPC 51 and to the boost compressor 72.

In one embodiment, a stator vane assembly for a gas turbine engine having a closed loop cooling circuit includes: casing or vane carrier (23); a higher pressure cooling air supply passage (13) in the casing or vane carrier (23); a higher pressure cooling air exit passage (15) in the casing or vane carrier (23); a stator vane (20) including an airfoil and being secured to the casing or vane carrier (23); an outer diameter endwall cavity (17) formed between the casing or vane carrier (23) and an outer diameter endwall of the stator vane (20); an inner diameter endwall cavity (18) formed on an inner diameter of the stator vane (20); a closed loop internal airfoil cooling circuit (14) formed within the airfoil of the stator vane (20); a first higher pressure cooling air feed tube (25) extending through the outer diameter endwall cavity (17) and connecting the higher pressure cooling air supply passage (13) to the internal airfoil cooling circuit (14) of the airfoil of the stator vane (20); and, a second higher pressure cooling air feed tube (25) extending through the outer diameter endwall cavity (17) and connecting the internal airfoil cooling circuit (14) of the airfoil of the stator vane (20) to the higher pressure cooling air exit passage (15).

In one aspect of the embodiment, the stator vane assembly also includes a lower pressure cooling air supply passage (16) in the outer diameter platform (23) and opening into the outer diameter endwall cavity (17); a lower pressure cooling air bypass passage (19) in the airfoil of the stator vane (20) connecting the outer diameter endwall cavity (17) to the inner diameter endwall cavity (18); an outer diameter lower pressure exit hole (21) connected to the outer diameter endwall cavity (17); and an inner diameter lower pressure exit hole (21) connected to the inner diameter endwall cavity (18).

In one aspect of the embodiment, the higher pressure cooling air supply passage (13), the higher pressure cooling air exit passage (15), and the internal airfoil cooling circuit (14) form a closed loop cooling circuit through the stator vane assembly.

In one aspect of the embodiment, the gas turbine engine further comprises a compressor (51) and a combustor (53), the higher pressure cooling air being at a higher pressure than a discharge pressure from the compressor (51) of the gas turbine engine such that spent cooling from the higher pressure cooling air exit passage (15) can be discharged into the combustor (53) of the gas turbine engine.

In one embodiment, a method of cooling a stator vane assembly of a gas turbine engine includes: passing a higher pressure cooling air through a closed loop internal airfoil cooling circuit (14) of an airfoil of the stator vane assembly to cool the airfoil; discharging the higher pressure cooling air from the internal airfoil cooling circuit (14) from the stator vane assembly; and passing the spent cooling air from the closed loop internal airfoil cooling circuit into the combustor of the gas turbine engine.

In one aspect of the embodiment, the method of cooling the stator vane assembly also includes passing a lower pressure cooling air into an outer diameter endwall cavity (17) of the stator vane assembly to cool the outer diameter endwall of the stator vane assembly; passing some of the lower pressure cooling air from the outer diameter endwall cavity (17) into an inner diameter endwall cavity (18) through the airfoil to cool the inner diameter endwall cavity; and discharging spent cooling air from both of the outer diameter and inner diameter endwall cavities (17, 18) outside of the airfoil of the stator vane.

In one aspect of the embodiment, the method of cooling a stator vane assembly of a gas turbine engine further includes passing the higher pressure cooling air through the stator vane assembly in a closed loop such that the higher pressure cooling air is not in fluid communication with the lower pressure cooling air.

In one aspect of the embodiment, the method of cooling a stator vane assembly of a gas turbine engine further includes passing the higher pressure cooling air through the stator vane assembly with enough pressure so that the discharged higher pressure cooling air from the stator vane assembly has enough pressure to flow into a combustor (53) of the gas turbine engine.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims

1. A stator vane assembly for a gas turbine engine having a closed loop cooling circuit, the stator vane assembly comprising:
an outer diameter platform;
a higher pressure cooling air supply passage in the outer diameter platform;
a higher pressure cooling air exit passage in the outer diameter platform;
a stator vane including an airfoil and being secured to the outer diameter platform;
an outer diameter endwall cavity formed between the outer diameter platform and the stator vane;
an inner diameter endwall cavity formed on an inner diameter of the stator vane;
an internal airfoil cooling circuit formed within the airfoil of the stator vane;
a lower pressure cooling air supply passage in the outer diameter platform and opening into the outer diameter endwall cavity;
a lower pressure cooling air bypass passage in the airfoil of the stator vane connecting the outer diameter endwall cavity to the inner diameter endwall cavity;
a first higher pressure cooling air feed tube extending through the outer diameter endwall cavity and connecting the higher pressure cooling air supply passage to the internal airfoil cooling circuit of the airfoil of the stator vane;
a second higher pressure cooling air feed tube extending through the outer diameter endwall cavity and connecting the internal airfoil cooling circuit of the airfoil of the stator vane to the higher pressure cooling air exit passage;
an outer diameter lower pressure exit hole connected to the outer diameter endwall cavity; and
an inner diameter lower pressure exit hole connected to the inner diameter endwall cavity.

2. The stator vane assembly for a gas turbine engine of claim 1, wherein:
the higher pressure cooling air supply passage, the higher pressure cooling air exit passage, and the internal airfoil cooling circuit form a closed loop cooling circuit through the stator vane assembly.

3. The stator vane assembly for a gas turbine engine of claim 1, wherein:
the gas turbine engine further comprises a compressor and a combustor, the higher pressure cooling air being at a higher pressure than a discharge pressure from the compressor of the gas turbine engine such that spent cooling from the higher pressure cooling air exit passage can be discharged into the combustor of the gas turbine engine.

4. A method of cooling a stator vane assembly of a gas turbine engine, the method comprising the steps of:
passing a higher pressure cooling air through an internal airfoil cooling circuit of an airfoil of the stator vane assembly to cool the airfoil;
discharging the higher pressure cooling air from the internal airfoil cooling circuit from the stator vane assembly;
passing a lower pressure cooling air into an outer diameter endwall cavity of the stator vane assembly to cool the outer diameter endwall of the stator vane assembly;
passing some of the lower pressure cooling air from the outer diameter endwall cavity into an inner diameter endwall cavity through the airfoil to cool the inner diameter endwall cavity; and
discharging spent cooling air from both of the outer diameter and inner diameter endwall cavities outside of the airfoil of the stator vane.

5. The method of cooling a stator vane assembly of a gas turbine engine of claim 4, further comprising the step of:
passing the higher pressure cooling air through the stator vane assembly in a closed loop such that the higher pressure cooling air is not in fluid communication with the lower pressure cooling air.

6. The method of cooling a stator vane assembly of a gas turbine engine of claim 4, and further comprising the step of:
passing the higher pressure cooling air through the stator vane assembly with enough pressure so that the discharged higher pressure cooling air from the stator vane assembly has enough pressure to flow into a combustor of the gas turbine engine.

7. A stator vane assembly for a gas turbine engine having a closed loop cooling circuit, the stator vane assembly comprising:
a casing or vane carrier;
a stator vane secured to the casing or vane carrier;
an OD endwall cavity formed between the casing or vane carrier and OD endwall of the stator vane;
the stator vane having a closed loop internal cooling air circuit;
a cooling air supply feed tube secured between the casing or vane carrier and the OD endwall of the stator vane to deliver cooling air to the closed loop internal cooling air circuit; and,
a cooling air discharge tube secured between the casing or vane carrier and the OD endwall of the stator vane to discharge cooling air from the closed loop internal cooling air circuit.

8. The stator vane assembly for a gas turbine engine of claim 7, wherein:
each cooling air supply feed tube has an enlarged annular section on each end of the feed tube to seal the feed tube and allow for movement sideways and axial.

9. The stator vane assembly for a gas turbine engine of claim 7, wherein:
the stator vane includes an ID endwall cavity; and,
the stator vane includes a cooling air passage that connects the OD endwall cavity to the ID endwall cavity.

10. The stator vane assembly for a gas turbine engine of claim 7, wherein:
the cooling air discharge tube connects spent cooling air from the closed loop internal cooling air circuit to a combustor of the gas turbine engine.

11. The stator vane assembly for a gas turbine engine of claim 7, wherein:
the casing or vane carrier includes a cooling air supply passage to supply cooling air to the OD endwall cavity.
